(19) United States
(12) Patent Application Publication
(10) Pub. No.: US 2013/0013892 A1
(43) Pub. Date: Jan. 10, 2013

(54) HIERARCHICAL MULTI-CORE PROCESSOR, MULTI-CORE PROCESSOR SYSTEM, AND COMPUTER PRODUCT

(75) Inventors: Koichiro Yamashita, Hachioji (JP); Hiromasa Yamauchi, Kawasaki (JP); Kiyoshi Miyazaki, Machida (JP); Takahisa Suzuki, Kawasaki (JP); Koji Kurihara, Kawasaki (JP)

(73) Assignee: FUJITSU LIMITED, Kawasaki-shi (JP)

(21) Appl. No.: 13/614,330

(22) Filed: Sep. 13, 2012

Related U.S. Application Data
(63) Continuation of application No. PCT/JP2010/054607, filed on Mar. 17, 2010.

(51) Int. Cl. G06F 9/30

(52) U.S. Cl. 712/34; 712/E09.032

(57) ABSTRACT

A hierarchical multi-core processor includes a core group for each hierarchy of a hierarchy group constituting a series of communication functions divided according to communication protocol, where a first core group of a given hierarchy among the hierarchy group is connected to a second core group of another hierarchy constituting a first communication function to be executed following a second communication function of the given hierarchy.

### CROSS REFERENCE TO RELATED APPLICATIONS

This application is a continuation application of International Application PCT/JP2010/054607, filed on Mar. 17, 2010 and designating the U.S., the entire contents of which are incorporated herein by reference.

### FIELD

The embodiments discussed herein are related to a hierarchical multi-core processor, a multi-core processor system, and a control program that execute processes concerning communication functions.

### BACKGROUND

Conventionally, technology is known, where a CPU group is used as one cluster in a multi-core processor system to execute application software (hereinafter, “application” (first conventional technology) (see, for example, Japanese Laid-Open Patent Publication Nos. 2007-199859 and 2002-342295). Further technology is known that regards clusters as a hierarchical structure and optimizes wiring consequent to the scale of a system becoming large by equivalently connecting all CPUs in a multi-core processor system, (second conventional technology) (see, for example, Japanese Laid-Open Patent Publication No. H5-204876).

However, according to the first conventional technology, one cluster is assigned to a process concerning one application and therefore, a problem arises in that when concurrently executed applications are increased, the clusters must also be increased and the scale of the system becomes large. According to the second conventional technology, though the clusters are regarded as a hierarchical structure, all the clusters in the same hierarchy need to be mutually connected and therefore, a problem arises in that the scale of the system becomes large.

### SUMMARY

According to an aspect of an embodiment, a hierarchical multi-core processor includes a core group for each hierarchy of a hierarchy group constituting a series of communication functions divided according to communication protocol, where a first core group of a given hierarchy among the hierarchy group is connected to a second core group of another hierarchy constituting a first communication function to be executed following a second communication function of the given hierarchy.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an example of a hardware configuration of a multi-core processor system;

FIG. 2 is a three-dimensional image diagram of a hierarchical multi-core processor 102 and a main CPU 101;

FIG. 3 is an explanatory diagram of a detailed example of “A” depicted in FIG. 2;

FIG. 4 is an explanatory diagram of an example of a hierarchy group used in an embodiment;

FIG. 5 is an explanatory diagram of an example of a program stored in memory 105;

FIG. 6 is an explanatory diagram of an example of a library group 502;

FIG. 7 is an explanatory diagram of an example of a process table 700;

FIG. 8 is a flowchart of a control process procedure executed by the main CPU 101 immediately after the power is turned on;

FIG. 9 is a flowchart of a control process procedure executed by a CP immediately after the power is turned on;

FIG. 10 is a flowchart of a control process procedure executed by the CP that has received a start-up instruction for the execution object in a start-up preparation state;

FIG. 11 is a flowchart of the control process procedure executed by the CP when the execution object of an application needing the start-up preparation comes to an end;

FIG. 12 is a first explanatory diagram of a first example;

FIG. 13 is an explanatory diagram of an example where a determination result is registered in the first example;

FIG. 14 is a second explanatory diagram of the first example;

FIG. 15 is an explanatory diagram of an example where a calculation result is registered in the first example;

FIG. 16 is a flowchart of a control process procedure executed by the main CPU 101 executed when an application is started up;

FIG. 17 is a flowchart of a control process procedure executed by the CP that receives a start-up instruction;

FIG. 18 is a flowchart of a control process procedure executed by the CP when the application that is started up according to the start-up instruction from a user comes to an end;

FIG. 19 is a first explanatory diagram of a second example;

FIG. 20 is an explanatory diagram of an example where the determination result is registered in the second example;

FIG. 21 is a second explanatory diagram of the second example; and

FIG. 22 is an explanatory diagram of an example where the calculation result is registered in the second example.

### DESCRIPTION OF EMBODIMENTS

Preferred embodiments of a hierarchical multi-core processor, a multi-core processor system, and a control program according to the present invention will be described in detail below with reference to the accompanying drawings.

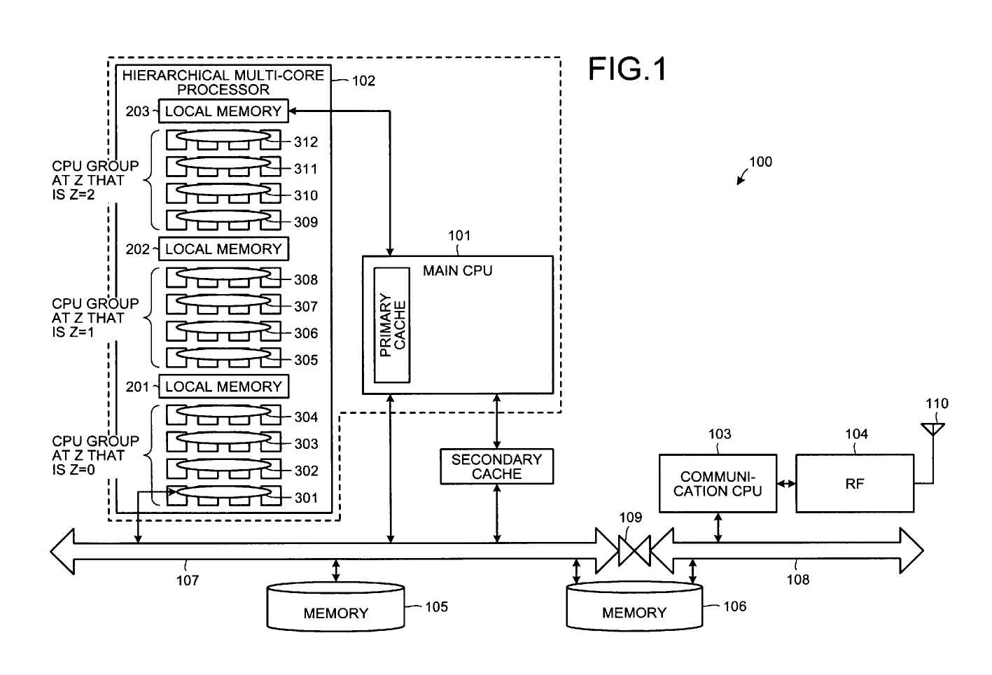

FIG. 1 is a block diagram of an example of a hardware configuration of the multi-core processor system. In FIG. 1, the multi-core processor system 100 includes a main central processor (CPU) 101, a hierarchical multi-core processor 102, a communication CPU 103, an RF 104, memory 105 and 106, and an antenna 110. The main CPU 101 and the memory 105 are connected by a bus 107. The communication CPU 103 and the memory 106 are connected by a bus 108. The buses 107 and 108 are connected through a bridge 109.

The main CPU 101 is a processor that governs control of the processes concerning application software, and includes primary cache. The communication CPU 103 is a processor that governs control of the processes concerning communication. A configuration is known to separately include the communication CPU 103 for communication and the main CPU 101 for applications.

The RF 104 is a high frequency processor, receives data from a network such as the Internet through the antenna 110, and transmits data to the network. In the embodiment, the RF 104 includes an analog (A)/digital (D) converter and a D/A converter, converts data from the network into a digital signal, and converts data from the communication CPU 103 into an analog signal.

The hierarchical multi-core processor 102 converts data from the communication CPU 103 into data that can be used by the main CPU 101 and converts data from the main CPU 101 into data that can be used by the communication CPU 103. The hierarchical multi-core processor 102 includes CPU groups (each indicated by □ in FIG. 1), cross-bar networks 301 to 312, and local memory 201 to 203.

In the hierarchical multi-core processor 102, the local memory 203 is connected to the main CPU 101, and the cross-bar network 301 is connected to the bus 107. The main CPU 101 and the CPUs of the hierarchical multi-core processor 102 are not directly connected to each other. For the main CPU 101 to deliver and receive information to/from the CPUs of the hierarchical multi-core processor 102, and receive information from the CPUs of the hierarchical multi-core processor 102, the main CPU 101 executes the delivery and reception through the local memory 203 and the memory 105. The hierarchical multi-core processor 102 and the main CPU 101 (encompassed by a dotted line) will be described in detail.

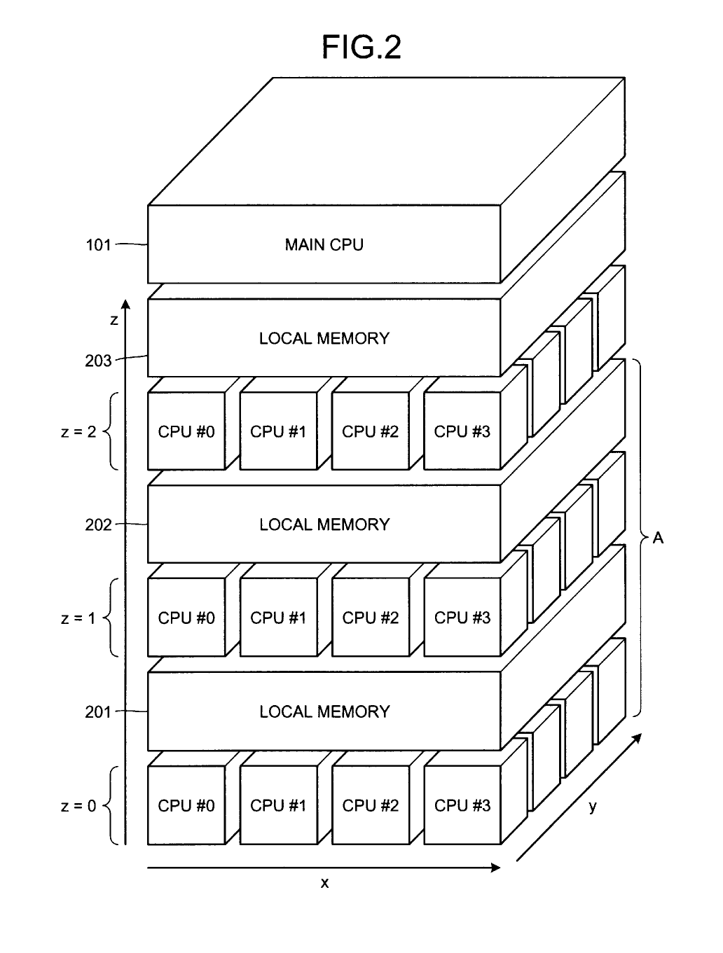

FIG. 2 is a three-dimensional image diagram of the hierarchical multi-core processor 102 and the main CPU 101. In FIG. 2, a “z-direction” represents the hierarchy. Along the z-direction, a state is depicted where each hierarchy of a hierarchy group constituting a series of communication functions divided according to communication protocols has a CPU group. A “communication protocol” is a rule for communication.

The “hierarchy group constituting a series of communication functions” is, for example, a hierarchy realized by a program of the OSI reference model described later. For example, a CPU group at “z” that is z=0 executes a process according to the protocol of a session layer; a CPU group at z that is z=1 executes a process according to the protocol of a presentation layer; and a CPU group at z that is z=2 executes a process according to the protocol of an application layer.

A CPU group of a given hierarchy of the hierarchy group is connected to another CPU group of another hierarchy constituting a communication function to be executed following the communication function of the one hierarchy, and the CPU group of the given hierarchy is not connected to a CPU group of a hierarchy constituting a communication function not executed following the communication function of the given hierarchy.

The CPU group of the session layer (the CPU group at z that is z=0) is connected through the local memory 201 to the CPU group of the presentation layer (the CPU group at z that is z=1) whose communication function is executed following that of the session layer. The CPU group of the session layer (the CPU group at z that is z=0) is not connected to the CPU group of the application layer (the CPU group at z that is z=2) whose communication function is not executed following that of the session layer. The CPU group of the session layer (the CPU group at z that is z=0) is connected to the CPU group of the application layer (the CPU group at z that is z=2) through the CPU group of the presentation layer.

The CPU group to execute the process concerning the protocol of the presentation layer (the CPU group at z that is z=1) is connected through the local memory 201 to the CPU group of the session layer (the CPU group at z that is z=0) whose communication function is executed following that of the presentation layer. The CPU group to execute the function of the presentation layer (the CPU group at z that is z=1) is connected through the local memory 202 to the CPU group of the application layer (the CPU group at z that is z=2) whose communication function is executed following that of the presentation layer.

The CPU group of the application layer (the CPU group at z that is z=2) is connected through the local memory 202 to the CPU group of the presentation layer (the CPU group at z that is z=1) whose communication function is executed following that of the application layer. The CPU group of the application layer (the CPU group at z that is z=2) is connected through the local memory 203 to the main CPU 101 of an application executed following the communication function of the presentation layer.

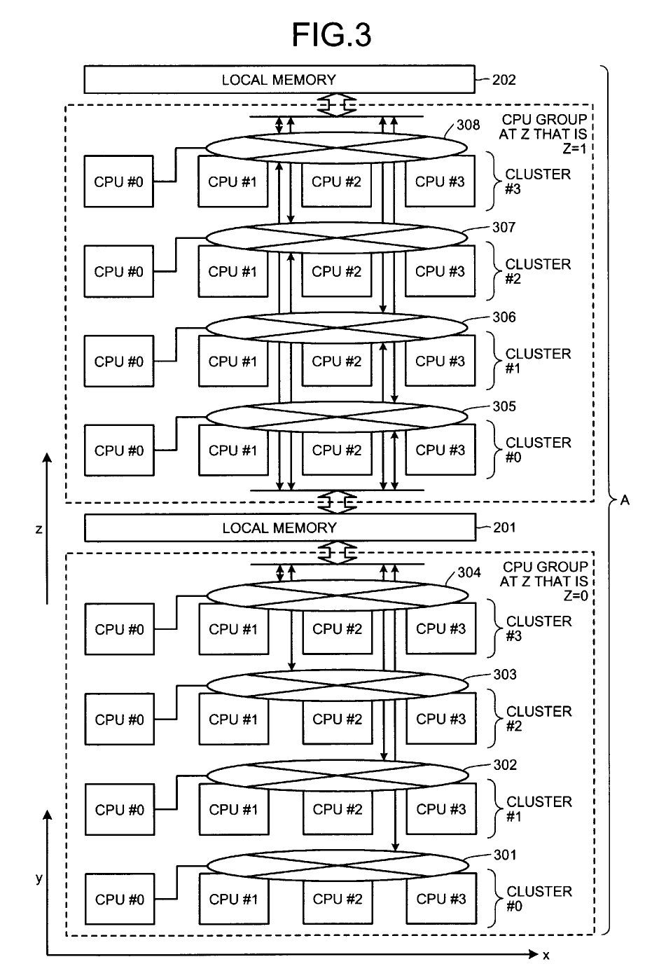

Each CPU of the hierarchical multi-core processor 102 is configured by an arithmetical operation circuit and a bit operation circuit (core) and is configured to be suitable for bit data processing of a packet. A “y-direction” and an “x-direction” will be described with reference to FIG. 3.

FIG. 3 is an explanatory diagram of a detailed example of “A” depicted in FIG. 2. The CPU group of each hierarchy is divided into multiple clusters. In FIG. 3, multiple clusters are depicted in the y-direction. In the embodiment, the CPU group of each hierarchy is divided into four clusters of clusters #0 to #3. The CPU group of each hierarchy may otherwise be referred to as “cluster group of each hierarchy”.

Each cluster has multiple CPUs. In FIG. 3, the CPUs included in a cluster are depicted in the x-direction. In the embodiment, each cluster has four CPUs including CPUs #0 to #3. The CPU #0 of each cluster is a control processor (hereinafter, “CP”) and executes dispatching to the CPUs in the cluster.

The CPU group of each cluster is connected by a cross bar switch. For example, at z that is z=0, the CPUs #0 to #3 of the cluster #0 are connected to the cross bar network 301 and the CPUs #0 to #3 of the cluster #1 are connected to the cross bar network 302. At z that is z=0, the CPUs #0 to #3 of the cluster #2 are connected to the cross bar network 303 and the CPUs #0 to #3 of the cluster #3 are connected to the cross bar network 304.

The cross bar networks 301 to 304 are connected to the local memory 201. In the embodiment, the main CPU 101 performs control to assign a different communication function to each cluster. The main CPU 101 performs control to not assign simultaneously a given communication function to multiple clusters and therefore, no data is delivered and received among the clusters. When any data is delivered or received among the clusters at z that is z=0, the delivery or the reception is executed through the local memory 201.

For example, at z that is z=1, the CPUs #0 to #3 of the cluster #0 are connected to the cross bar network 305 and the CPUs #0 to #3 of the cluster #1 are connected to the cross bar network 306. At z that is z=1, the CPUs #0 to #3 of the cluster #2 are connected to the cross bar network 307 and the CPUs #0 to #3 of the cluster #3 are connected to the cross bar network 308. The cross bar networks 305 to 308 are connected to the local memory 201 and 202.

For example, though not depicted, at z that is z=2, the CPUs #0 to #3 of the cluster #0 are connected to the cross bar network 309 and the CPUs #0 to #3 of the cluster #1 are connected to the cross bar network 310. At z that is z=2, the CPUs #0 to #3 of the cluster #2 are connected to the cross bar network 311 and the CPUs #0 to #3 of the cluster #3 are connected to the cross bar network 312. The cross bar networks 309 to 312 are connected to the local memory 202 and 203.

The CP of each cluster performs control to cause the CPUs in each cluster to execute in parallel the process concerning the protocol assigned to each cluster. Iteration may be present depending on the process concerning the communication function and therefore, the throughput can be improved by causing the CPUs of the cluster to which the process concerning the communication function to execute in parallel the iteration. A hierarchy group used in the embodiment will be described.

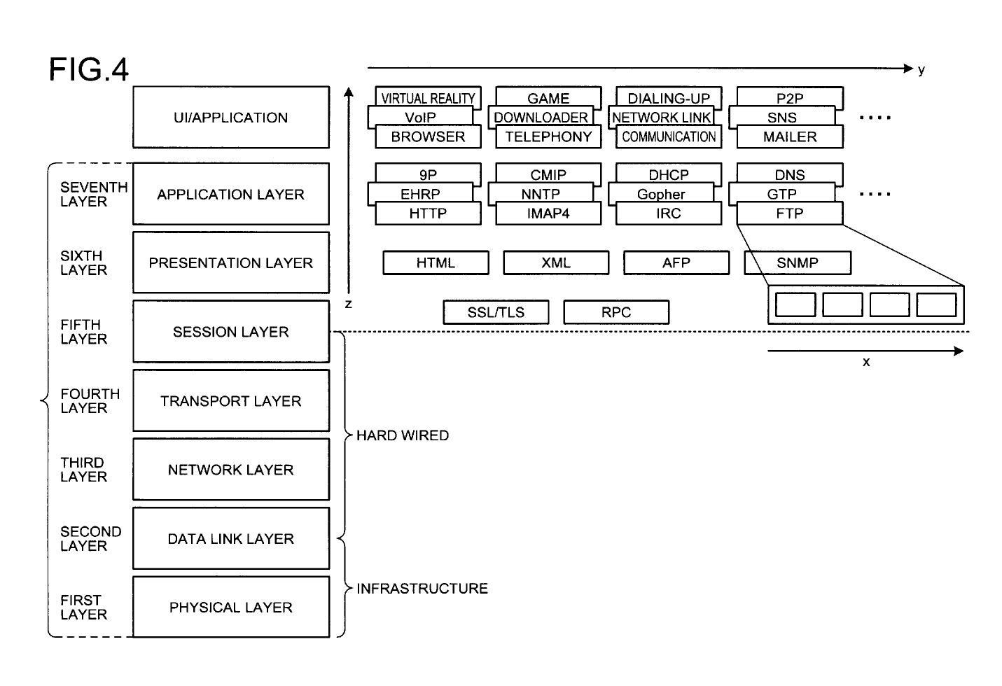

FIG. 4 is an explanatory diagram of an example of the hierarchy group used in the embodiment. In the embodiment, the description will be made taking an example of the OSI reference model as the hierarchy group as above. The OSI reference model is a model formed by dividing the communication functions into those in a hierarchy structure as known and is configured by a structure including a total of seven layers, including a first to a seventh layers.

In the OSI reference model, the first layer is a physical layer, the second layer is a data link layer, the third layer is a network layer, the fourth layer is a transport layer, the fifth layer is a session layer, the sixth layer is a presentation layer, and the seventh layer is an application layer. In the embodiment, a user interface (UI) and an application program (hereinafter, collectively “UI/application”) will be used as a hierarchy higher than the application layer in addition to the OSI reference model.

A portion of the physical layer and the data link layer, respectively, is infrastructure. A portion of the data link layer and a portion of the network layer, the transport layer, and the session layer, respectively, are realized by hard-wired logic. A portion of the session layer and the presentation layer, the application layer, and the UI/application are realized by programs and a CPU loads and executes the programs. In the embodiment, the CPUs are determined in advance for executing such processes as the process concerning the protocol of the session layer, the process concerning the protocol of the presentation layer, the process concerning the protocol of the application layer, and the process concerning the UI/application as above.

The process concerning the protocol of the session layer is executed by the CPU group at z that is z=0. The process concerning the protocol of the presentation layer is executed by the CPU group at z that is z=1. The process concerning the protocol of the application layer is executed by the CPU group at z that is z=2. The process concerning the UI/application is executed by the main CPU 101.

Here, a protocol example for each layer will be given. Secure socket layer (SSL)/transport layer security (TLS), and remote procedure call (RPC) can be given as examples of the protocol of the session layer.

Hyper text markup language (HTML), extensible markup language (XML), Apple filing protocol (AFP), and simple network management protocol (SNMP) can be given as examples of the protocol of the presentation layer.

Hypertext transfer protocol (HTTP), endpoint handlespace redundancy protocol (EHRP), 9P, Internet message access protocol (IMAP4), network news transfer protocol (NNTP), common management information protocol (CMIP), Internet relay chat (IRC), Gopher, dynamic host configuration protocol (DHCP), file transfer protocol (FTP), GTP (general packet radio service (GPRS) tunneling protocol), and domain name system (DNS) can be given as examples of the protocol of the application layer.

Finally, taking an example of a mobile telephone, the UI/application can be a browser, a Voice over Internet Protocol (VoIP), a virtual reality application, telephony, a downloader, a game, a communication application, a network link, a dialing-up application, a mailer, a social network service (SNS), and peer-to-peer (P2P).

The UI is started up immediately after the power is turned on. On the other hand, an application is started up in response to a start-up instruction from a user, is started up by an external factor, etc. The “external factor” can be reception of an e-mail or arrival of a telephone call. Therefore, the mailer and the dialing-up application are applications that immediately enter stand-by states after the power is turned on. The mailer is immediately started up in response to reception of an e-mail and the dialing-up application is immediately started up in response to arrival of a telephone call.

In the embodiment, an example of a receiving process of a mailer will be described as a process immediately entering a stand-by state after the power is turned on, and an example of a process concerning a browser will be described as a process executed according to a start-up instruction from a user. To execute the receiving process of the mailer, for example, IMAP4 of the application layer, SNMP of the presentation layer, and SSL of the session layer are used. To execute the process concerning the browser, for example, HTTP and FTP of the application layer, HTML and XML of the presentation layer, and TLS of the session layer are used.

In FIG. 2, the z-direction represents hierarchy, the y-direction represents cluster, and the x-direction represents CPUs in the cluster. However, in FIG. 4, the z-direction represents hierarchy, the y-direction represents protocol, and the x-direction represents parallel processing concerning the protocol. FIGS. 2 and 4 depict states where the protocol corresponding to a hierarchy is assigned to the cluster of the hierarchy, such that processes concerning different protocols are assigned to different clusters, and where the cores in each cluster are caused to execute in parallel the process concerning the protocol. Each cluster of the hierarchical multi-processor 102 has the four CPUs and therefore, for example, when the process concerning FTP is configured by four tasks as depicted in FIG. 4, each of the CPUs of the cluster to which the process concerning FTP is assigned can be assigned one of the tasks.

Referring back to FIG. 1, the memory 105 and 106 will be described. The memory 106 stores various kinds of information and is used as a work area of the communication CPU 103. The memory 105 stores various kinds of information and is used as a work area of the main CPU 101. The memory 105 and 106 are each storage devices such as, for example, read-only memory (ROM), random access memory (RAM), flash memory, or a hard disk drive.

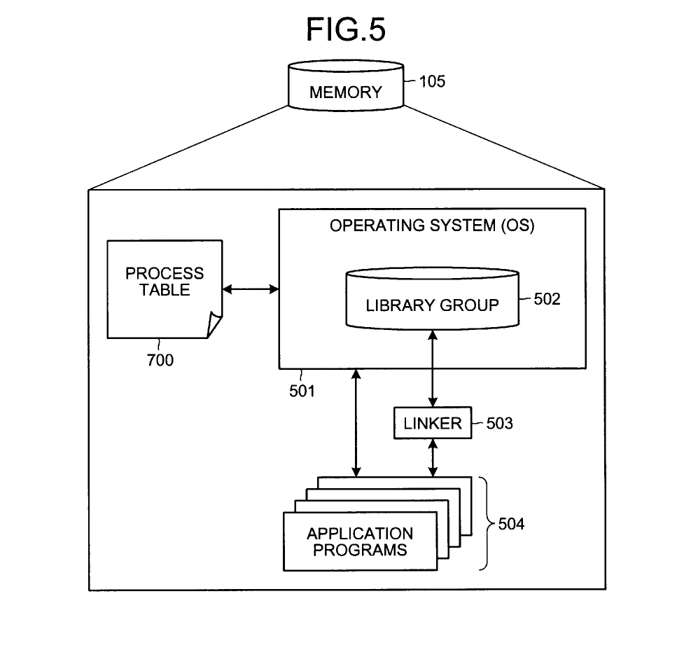

FIG. 5 is an explanatory diagram of an example of a program stored in the memory 105. The memory 105 stores an OS 501, application programs 504, a linker 503, and a process table 700. The OS 501 has a library group 502 and a function of performing control to assign the process concerning the protocol of each hierarchy to the cluster group corresponding to the hierarchy and of using the process table 700 to perform control to determine to which cluster of the cluster group corresponding to the hierarchy, the process is to be assigned.

The library group 502 is a set of libraries. A “library” is a program that includes multiple highly versatile program parts as a file, and operates as a part of another program that operates on the OS 501 such as the application program 504. The library cannot be executed alone.

By being loaded on the main CPU 101, the application program 504 and the OS 501 causes the main CPU 101 to execute coded processes. The main CPU 101 executes the process to perform control using the process table 700 to determine to which cluster of the CPU cluster group corresponding to the hierarchy, the process concerning the protocol of each hierarchy is assigned.

Although not depicted, a program stored in the memory 105, has a function of controlling the CPUs in each cluster to execute, in parallel, the process concerning the protocol assigned to each cluster. The program is loaded on the CP of each cluster of the hierarchical multi-core processor 101 and thereby, the CP of each cluster of the hierarchical multi-core processor 101 is caused to execute the coded process.

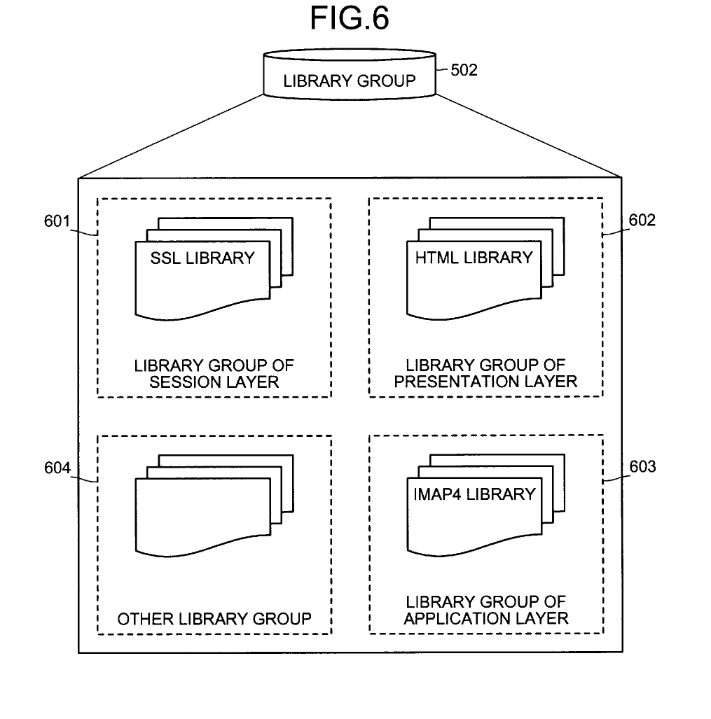

FIG. 6 is an explanatory diagram of an example of the library group 502. The library group 502 is stored in the memory 105, and has the library group of the protocols and a library group 604 that is not a library of the protocols. The library group of the protocols is classified into three library groups respectively for a hierarchy that includes a library group 601 of the session layer, a library group 602 of the presentation layer, and a library group 603 of the application layer. The main CPU 101 can identify which hierarchy's protocol a library of each protocol is.

For example, a library of SSL, a library of TLS, and a library of a driver belong to the library group 601 of the session layer. For example, a library of HTML and a library of XML belong to the library group 602 of the presentation layer. For example, a library of IMAP4 and a library of FTP belong to the library group 603 of the application layer.

Referring back to FIG. 5, the linker 503 is a program to link the application program 504 and a library used by the application program 504 to each other. The application program 504 is a program operating on the OS 501, and invokes libraries and executes processes when necessary. In the case of a browser, for example, the linker 503 links the library of HTTP, the library of FTP, the library of HTML, the library of XML, and the library of TLS to each other from the library group. A library is referred to as “execution object” that is identified by the linkage by the linker 503.

The process table 700 indicates for each hierarchy, the protocol that is or that is scheduled to be assigned to the CPU group that executes processes concerning the protocol of the hierarchy, the cluster to which the protocol is assigned among the CPU group and the number of CPUs to which the protocol is assigned among the cluster (an assignment state or an assignment schedule).

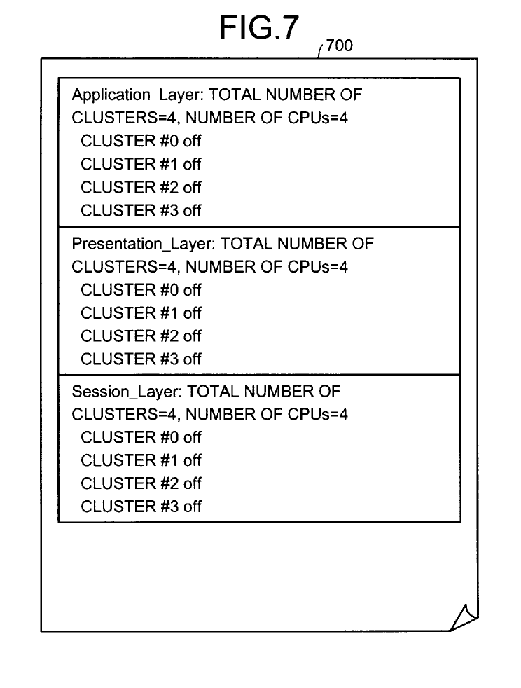

FIG. 7 is an explanatory diagram of an example of the process table 700. The process table 700 indicates the assignment state and the assignment schedule at the time immediately after the power is turned on, and is classified into “Application_Layer:”, “Presentation_Layer:”, and “Session_Layer:”. “Application_Layer:”, “Presentation_Layer:”, and “Session_Layer:”, which respectively indicate the assignment state or the assignment schedule for the CPU group corresponding to the application layer, the presentation layer, and the session layer. The names of the layers indicate the z-direction depicted in FIG. 2.

In the assignment state and the assignment schedule of each layer, the total number of clusters represents the number of clusters and indicates the y-direction depicted in FIG. 3. The number of CPUs represents the number of CPUs of each cluster and indicates the x-direction depicted in FIG. 4. As depicted in FIG. 4, at z that is z=0, the clusters #0 to #3 are present and therefore, “the total number of clusters=4” and each cluster includes CPUs #0 to #3 and therefore, “the number of CPUs=4”.

The process table 700 at the time immediately after the power is turned on does not yet have an application that is in the stand-by state or application that has been executed and therefore, nothing is assigned to any of the clusters. “Off” represents that all of the CPUs in the cluster are in an off state. The “off state” is the state where no clock and no power are supplied. On the other hand, an “on state” is the state where a clock and power are supplied. The hierarchical multi-core processor 102 has two modes, including a normal mode and a low power consumption mode. The “low power consumption mode” refers to, for example, a state where the frequency of a clock supplied to the CPU is reduced.

Only the cross bar networks and the main CPU 101 of the hierarchical multi-core processor 102 are connected to the buses and therefore, the CPUs remaining after excluding the CPUs of the cluster #0 cannot directly refer to the libraries of the protocols and the process table 700, at z that is z=0 of the CPUs of the hierarchical multi-core processor 102. For libraries, the CP of the cluster #0 at z that is z=0 or the main CPU 101 duplicate(s) the library of the protocols and the CP of each cluster transfers the duplicated library to accessible local memory.

The description will be made taking an example where the CP of the cluster #1 loads and maps the library of HTTP at z that is z=1. The CP of the cluster #0 at z that is z=0 accesses the memory 105 through the cross bar network, identifies the library of HTTP from the library group 603 of the application layer of the library group 502, and duplicates the library of HTTP identified. The CP of the cluster #0 at z that is z=0 transfers the library of HTTP duplicated to the local memory 201. The CP of the cluster #1 at z that is z=1 accesses the local memory 201 through the cross bar network 305 and loads and maps the library of HTTP transferred.

A control process procedure of the multi-core processor at the time immediately after the power is turned on will be described and subsequently, a control process procedure of the multi-core processor, executed when a start-up instruction of an application is received from a user during operation will be described.

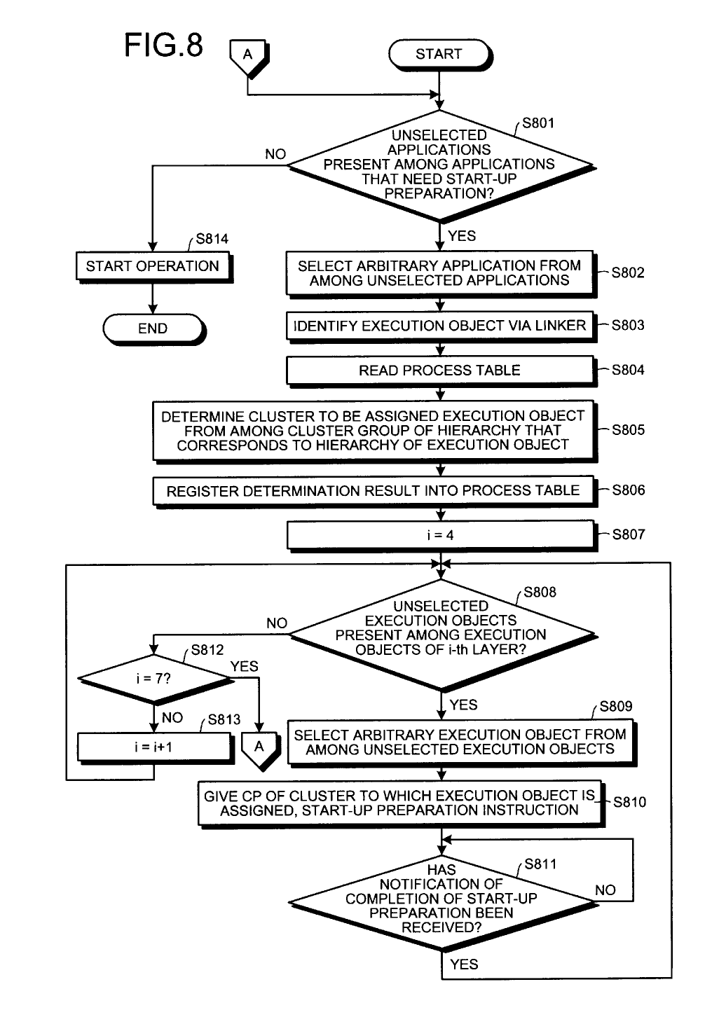

FIG. 8 is a flowchart of a control process procedure executed by the main CPU 101 immediately after the power is turned on. The main CPU 101 determines whether any unselected applications are present among the applications that need start-up preparation (step S801). The “applications that need start-up preparation immediately after the power is turned on” can be the mailer and the dialing-up application as above.

If the main CPU 101 determines that an unselected application is present among the applications that need start-up preparation (step S801: YES), an arbitrary application is selected from among the unselected applications (step S802). The main CPU 101 links to the library concerning the selected application using the linker and thereby, identifies an execution object (step S803).

The main CPU 101 reads the process table (step S804) and determines a cluster to be assigned the execution object from among the cluster group of the hierarchy that corresponds to the hierarchy of the execution object (step S805). In the example, assignment of a process for the code described in the execution object (library) is indicated, while the assignment of an execution object (library) is omitted. For example, the main CPU 101 determines the cluster to which an execution object is to be assigned, by aggregating the load amounts of the clusters.

The main CPU 101 registers the determination result into the process table (step S806), sets “i” to be i=4 (step 807), and determines whether any unselected execution objects are present among execution objects of the i-th layer (step S808). If the main CPU 101 determines that an unselected execution object is present among the execution objects of the i-th layer (step S808: YES), the main CPU 101 selects an arbitrary execution object from among the unselected execution objects (step S809). The main CPU 101 gives the CP of the cluster to which the execution object is assigned, a start-up preparation instruction (step S810) and determines whether the CP has received notification of completion of the start-up preparation (step S811).

If the main CPU 101 determines that the CP 101 has not received notification of the completion of the start-up preparation (step S811: NO), the procedure returns to step S811. On the other hand, if the main CPU 101 determines that the CP has received notification of the completion of the start-up preparation (step S811: YES), the procedure returns to step S808. If the main CPU 101 determines that no unselected execution object is present among the execution objects of the i-th layer (step S808: NO), the main CPU 101 determines whether “i” is i=7 (step S812). If the main CPU 101 determines that i is not i=7 (step S812: NO), the main CPU 101 sets i to be i=i+1 (step S813) and the procedure returns to step S808.

On the other hand, if the main CPU 101 determines that i is i=7 (step S812: YES), the procedure returns to step S801. If the main CPU 101 determines that no unselected application is present among the applications that need start-up preparation (step S801: NO), the main CPU 101 starts operation (step S814) and the series of process steps comes to an end.

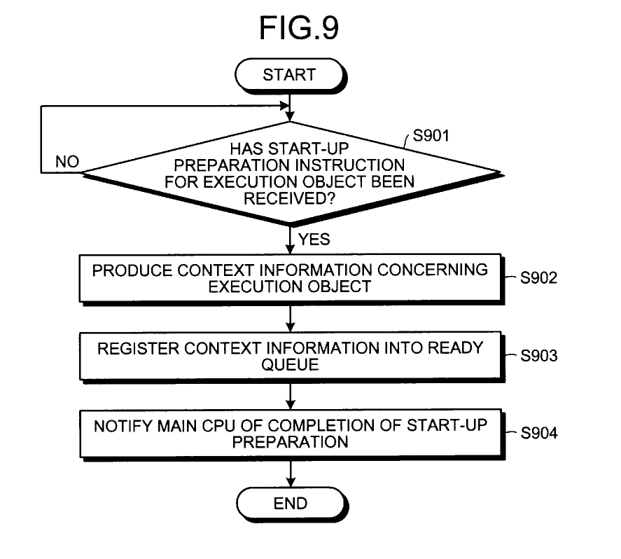

FIG. 9 is a flowchart of a control process procedure executed by the CP immediately after the power is turned on. The CP of the cluster to which the execution object is assigned (simply “CP” in the description with reference to FIG. 9) determines whether the CP has received a start-up preparation instruction for the execution object from the main CPU (step S901). “Start-up preparation for the execution object” refers to causing a coded process in the execution object (library) (hereinafter, “process concerning the execution object” or “process concerning the library”) to be able to immediately be executed. In the embodiment, the process concerning the library of the protocol and the process concerning the protocol are used having the same meaning.

If the CP determines that the CP has not received a start-up preparation instruction for the execution object from the main CPU (step S901: NO), the procedure returns to step S901. On the other hand, if the CP determines that the CP has received a start-up preparation instruction for the execution object (step S901: YES), the CP maps the execution object on the local memory and produces context information concerning the execution object (step S902). As is known, the context information indicates the internal state of the program and on which part of the memory the program is disposed. In this case, the process concerning the execution object is mapped on the local memory accessible from the cluster to which the execution object is assigned, and information indicating in which part of the local memory the process is mapped, is produced as the context information.

When the CP registers the context information into a ready queue (step S903), the CP notifies the main CPU of completion of the start-up preparation (step S904) and the series of process steps comes to an end. As is known, the “ready queue” is a data structure to manage executable tasks. The CP extracts the context information concerning the execution object registered in the ready queue and thereby, is able to immediately execute the process concerning the execution object. The applications that need start-up preparation immediately after the power is turned on are in a stand-by state.

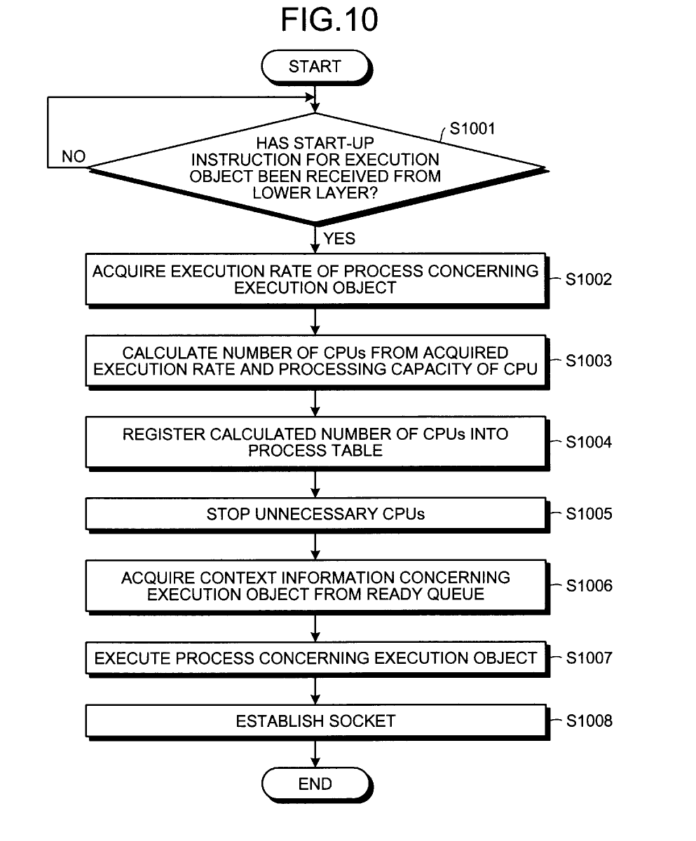

FIG. 10 is a flowchart of a control process procedure executed by the CP that has received a start-up instruction for the execution object in the start-up preparation state. The CP of the cluster to which the execution object in the start-up preparation state is assigned (simply “CP” in the description with reference to FIG. 10) determines whether the CP has received a start-up instruction for the execution object from a lower layer (step S1001). The “start-up instruction for the execution object” refers to a start-up instruction for a process concerning an execution object. If the CP determines that the CP has not received a start-up instruction for the execution object from a lower layer (step S1001: NO), the procedure returns to step S1001.

On the other hand, if the CP determines that the CP has received a start-up instruction for the execution object from the lower layer (step S1001: YES), the CP acquires an execution rate of the process concerning the execution object for which a start-up instruction has been received (step S1002). The “execution rate” is a band and the CP is able to acquire the execution rate using a “Ping” command.

The CP calculates the number of CPUs from the execution rate of the process concerning the execution object [bps (bit per second)] and the processing capacity of the CPU [bps] (step S1003), and registers the number of CPUs calculated into the process table (step S1004). The registration into the process table will be described. For the CPUs of the cluster #0 at z that is z=0 and the main CPU 101, the CP accesses the memory 105 and performs direct registration into the process table 700. For the CPUs remaining after excluding the CPUs of the cluster #0 at z that is z=0 of the CPUs of the hierarchical multi-core processor 102, the CP notifies the CPUs of the cluster #0 at z that is z=0 or the main CPU 101 to register the number of CPUs calculated into the process table 700.

The CP stops unnecessary CPUs (step S1005), acquires the context information concerning the execution object from the ready queue (step S1006), and executes the process concerning the execution object (step S1007). The “unnecessary CPUs” refers to, for example, when the process concerning the protocol is executed using three CPUs of the four CPUs in a cluster, the CPU remaining after excluding the three CPUs from the four CPUs. The CP establishes a socket (step S1008) and the series of process steps comes to an end.

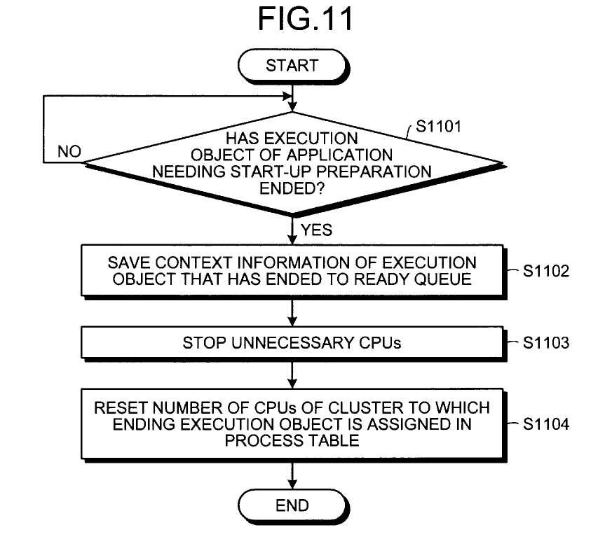

FIG. 11 is a flowchart of the control process procedure executed by the CP when the execution object of an application needing the start-up preparation comes to an end. The CP of the cluster to which the execution object of the application needing start-up preparation (simply “CP” in the description with reference to FIG. 11) determines whether the execution object of the application needing the start-up preparation has ended (step S1101). If the CP determines that the execution object of the application needing the start-up preparation has not ended (step S1101: NO), the procedure returns to step S1101.

If the CP determines that the execution object of the application needing the start-up preparation has ended (step S1101: YES), the CP saves to the ready queue, the context information of the execution object that has ended (step S1102). The CP stops the unnecessary CPUs (step S1103) and resets the number of CPUs of the cluster to which the ending execution object is assigned in the process table (step S1104), and the series of process steps comes to an end.

A specific example will be described of a control process of the multi-core processor system 100 executed immediately after the power is turned on.

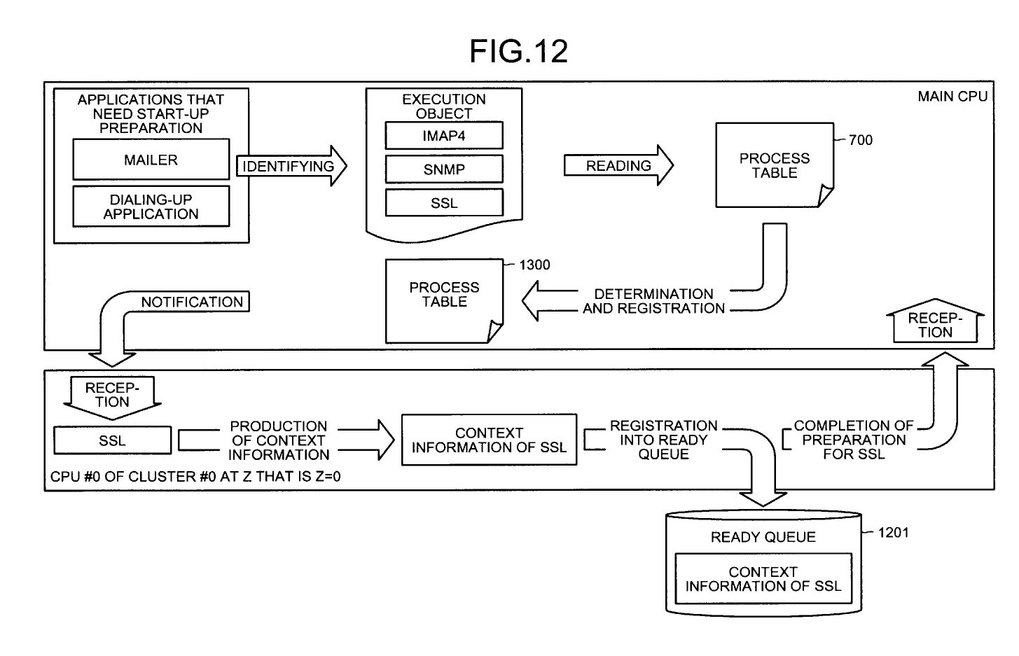

FIG. 12 is a first explanatory diagram of a first example. FIG. 12 depicts a control process executed by the main CPU 101 executed immediately after the power is turned on, and a control process executed by the CPU #0 in the cluster # (the CP in the cluster #) at z that is z=0. Although the application needing the start-up preparation can be the mailer or the dialing-up application, the description will be made taking a receiving process of the mailer as an example.

The main CPU 101 identifies an execution object necessary for the receiving process of the mailer from the library group using the linker. The main CPU 101 identifies the libraries of SSL, SNMP, and IMAP4 as the execution object. In FIG. 12, the library of SSL is simply denoted by “SSL”; the library of SNMP is simply denoted by “SNMP”; and the library of IMAP4 is simply denoted by “IMAP4”.

The main CPU 101 reads the process table 700, determines the cluster to be assigned the execution object, and registers the determination result into the process table 700. If the main CPU 101 refers to, for example, the process table 700, and nothing has been assigned, the execution object may consequently be assigned to any cluster. If the cluster to which the execution object is assigned is in an off state, the main CPU 101 switches the mode of the cluster to the low power consumption mode in the on state.

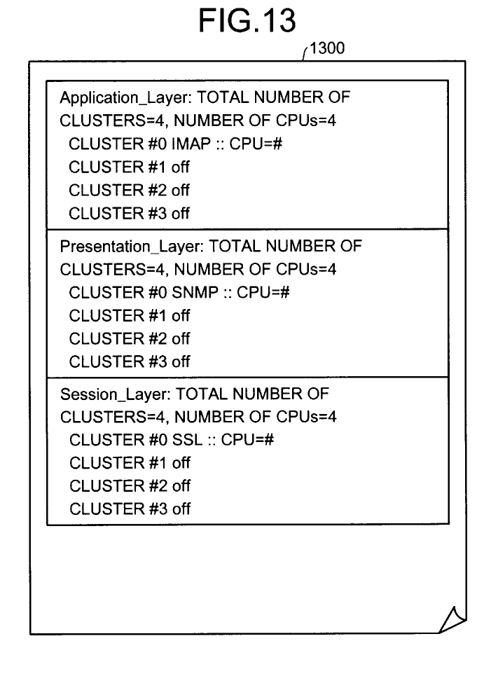

FIG. 13 is an explanatory diagram of an example where the determination result is registered in the first example. Because IMAP4 is the protocol of the application layer, the library of IMAP4 is scheduled to be assigned to the cluster #0 of “Application_Layer:” in a process table 1300. “CPU=#” indicates that the number of CPUs among the cluster #0 and to which the process concerning the protocol is assigned, has not been determined.

Because SNMP is a protocol of the presentation layer, the library of SNMP is scheduled to be assigned to the cluster #0 of “Presentation_Layer:” in the process table 1300. Because SSL is a protocol of the session layer, the library of SSL is scheduled to be assigned to the cluster #0 of “Session_Layer:” in the process table 1300.

Referring back to FIG. 12, because the process concerning SSL is assigned to the cluster #0 at z that is z=0, a start-up preparation instruction for the process concerning SSL is given to the CP of the cluster #0 at z that is z=0 (the CPU #0 of the cluster #0 at z that is z=0). When the CP of the cluster #0 at z that is z=0 receives the start-up preparation instruction for the process concerning SSL, the CP maps the process concerning SSL to the local memory 203 (or 202) to produce the context information.

The CPU #0 of the cluster #0 at z that is z=0 registers the context information concerning SSL into a ready queue 1201 and notifies the main CPU 101 of the completion of the start-up preparation of the process concerning SSL. The ready queue 1201 is stored in, for example, the local memory 201. When the main CPU 101 receives the notification of the completion of the start-up preparation of the process concerning the SSL, the main CPU 101 notifies the CPU #0 of the cluster #0 at z that is z=1 to which the process concerning SNMP is assigned, of the start-up preparation instruction. When the main CPU 101 receives the notification of the completion of the start-up preparation of the process concerning SNMP, the main CPU 101 notifies the CPU #0 of the cluster #0 at z that is z=0 to which the process concerning IMAP4 is assigned, of the start-up preparation instruction.

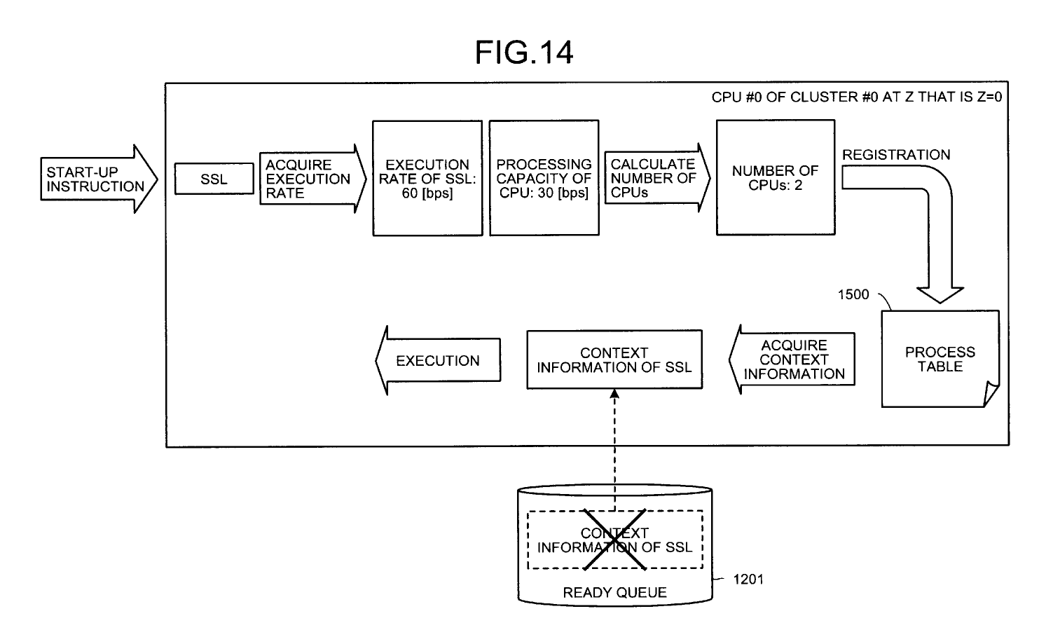

FIG. 14 is a second explanatory diagram of the first example. An example of a case where the start-up instruction of SSL is receives will be described with reference to FIG. 14, continued from the description with reference to FIG. 13. When the CPU #0 of the cluster #0 at z that is z=0 receives the start-up instruction of SSL, the CPU #0 acquires the execution rate of the process concerning SSL. The execution rate of the process concerning SSL is assumed to be 60 [bps] and the processing capacity of each CPU is assumed to be 30 [bps].

The CPU #0 of the cluster #0 at z that is z=0 calculates the number of CPUs necessary for the process concerning SSL by dividing the execution rate of the process concerning SSL by the processing capacity of each CPU. Therefore, the number of CPUs necessary for the process concerning SSL is two. The CPU #0 of the cluster #0 at z that is z=0 registers the number of CPUs calculated thereby into a process table 1500.

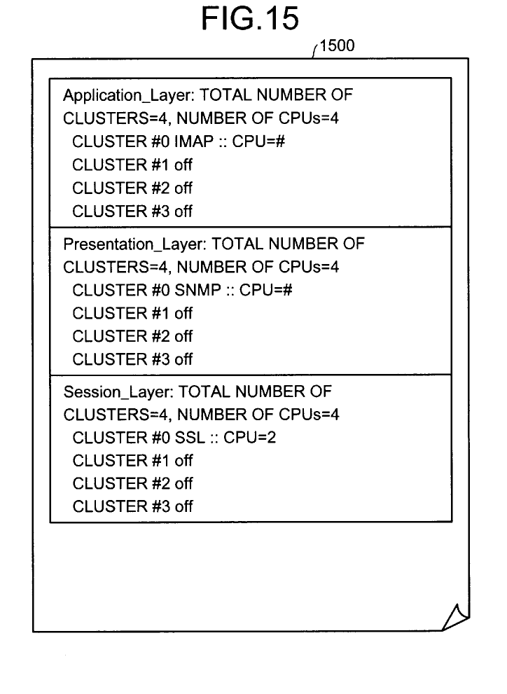

FIG. 15 is an explanatory diagram of an example where the calculation result is registered in the first example. “SSL::CPU=2” is registered for the cluster #0 of “Session_Layer:” in a process table 1500.

Referring back to FIG. 14, the CPU #0 of the cluster #0 at z that is z=0 stops the unnecessary CPUs (switches the unnecessary CPUs to the off state) and switches the mode of the CPUs to which the process concerning SSL is assigned from the low power consumption mode to the normal mode. The CPU #0 of the cluster #0 at z that is z=0 acquires the context information concerning SSL from the ready queue 1201 and executes the process concerning SSL to establish a socket. The context information for SSL is acquired by the CPU #0 of the cluster #0 at z that is z=0 and is deleted from the ready queue. When the CPU #0 of the cluster #0 at z that is z=0 executes the process concerning SSL, the CPU #0 gives a start-up instruction for SNMP of the presentation layer.

When the process concerning SSL comes to an end, the CPU #0 of the cluster #0 at z that is z=0 saves the context information for SSL to the ready queue 1201 and stops the unnecessary CPUs (switches the unnecessary CPUs into the off state). The CPU #0 of the cluster #0 at z that is z=0 reads the process table 1500 and resets the number of CPUs that are assigned to SSL. A case will be described where the main CPU 101 receives from a user, a start-up instruction for an application.

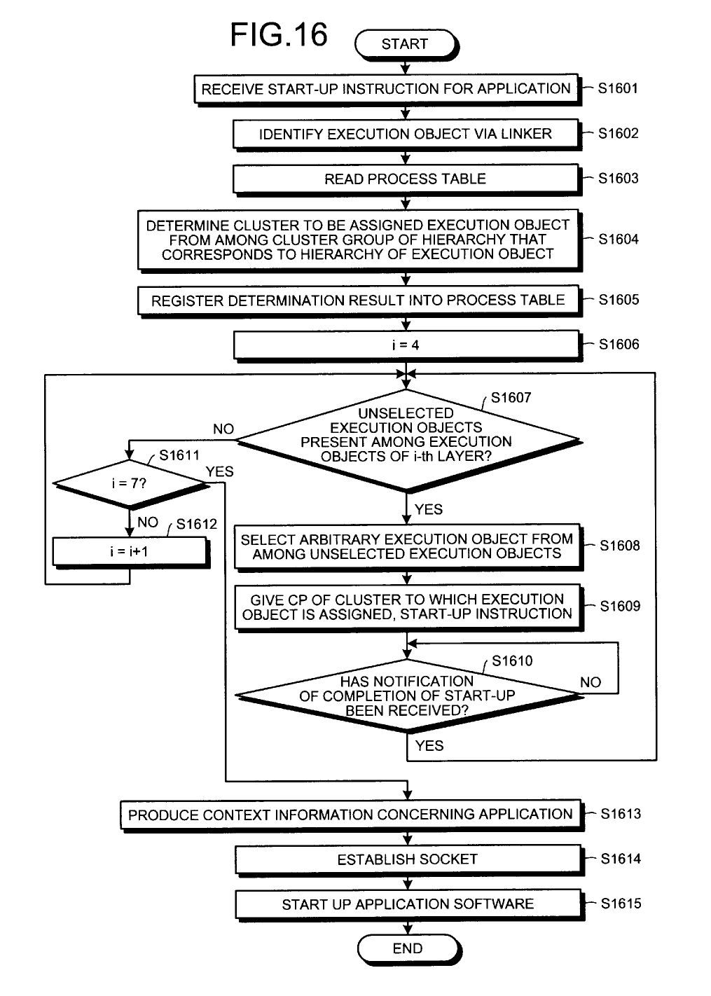

FIG. 16 is a flowchart of a control process procedure executed by the main CPU 101 executed when an application is started up. The control process procedure executed when the main CPU 101 receives from a user, a start-up instruction for the application will be described. The main CPU 101 receives the start-up instruction of an application program (step S1601).

Processes executed at steps S1602 to S1608 are same as those executed at steps S803 to S809, and processes executed at steps S1611 and S1612 are same as those executed at steps S812 and S813. Therefore, steps S1602 to S1608, S1611, and S1612 will not again be described. Steps S1609, S1610, and S1613 to 1615 will be described.

The main CPU 101 give the CP of the cluster to which the execution object is assigned, a start-up instruction (step S1609) and determines whether the CP has received notification of completion of the start-up (step S1610). If the main CPU 101 determines that the CP has not received notification of completion of start-up (step S1610: NO), the procedure returns to step S1610. On the other hand, if the main CPU 101 determines that the CP has received notification of completion of start-up (step S1610: YES), the procedure returns to step S1607.

The main CPU 101 produces the context information concerning the application at step S1613 (step S1613), establishes a socket between the communication layers (step S1614), and starts up the application software (step S1615), and the series of process steps comes to an end.

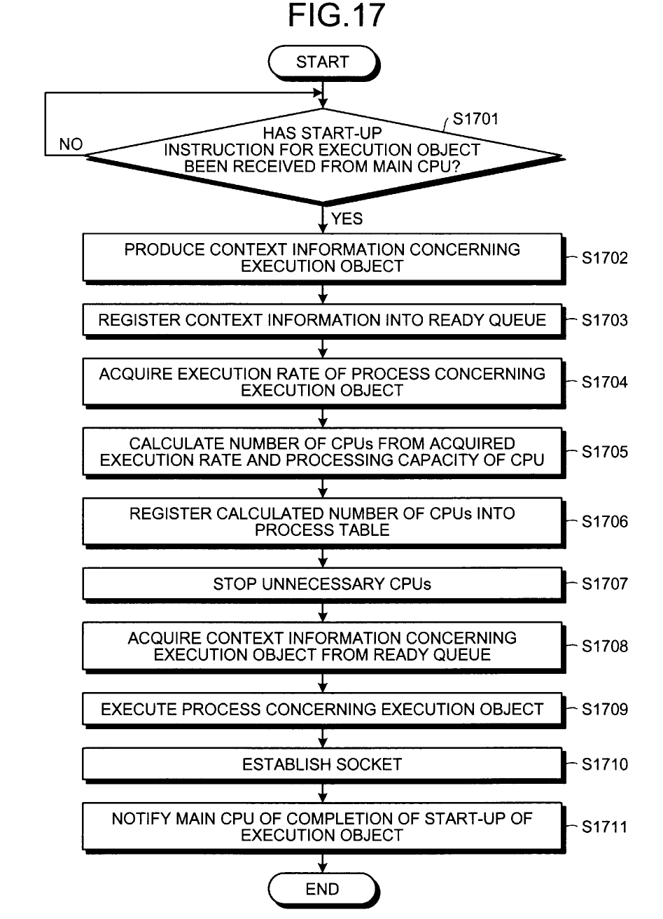

FIG. 17 is a flowchart of a control process procedure executed by the CP that receives a start-up instruction. The CP of the cluster to which the execution object is assigned (simply “CP” in the description with reference to FIG. 17) determines whether the CP has received a start-up instruction for the execution object from the main CPU (step S1701). If the CP determines that the CP has not received a start-up instruction for the execution object from the main CPU (step S1701: NO), the procedure returns to step S1701.

On the other hand, if the CP determines that the CP has received a start-up instruction for the execution object from the main CPU (step S1701:: YES), the CP produces the context information concerning the execution object whose start-up instruction has been received (step S1702) and registers the context information into the ready queue (step S1703). Processes executed at steps S1704 to S1710 are same as those executed at steps S1002 to S1008 and will not again be described. Following step S1710, the CP notifies the main CPU of the completion of the start-up of the execution object (step S1711) and the series of process steps comes to an end.

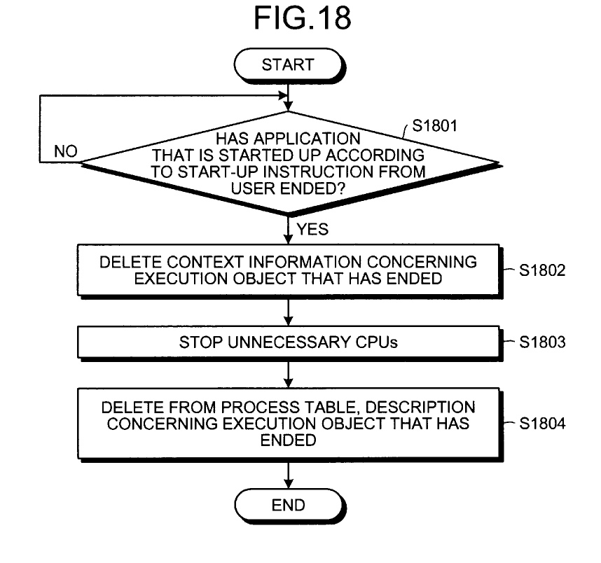

FIG. 18 is a flowchart of a control process procedure executed by the CP when the application that is started up according to the start-up instruction from a user comes to an end. The application is an application started up according to the start-up instruction from the user, and the CP of the cluster to which the execution object of the application needing no start-up preparation immediately after the power is turned on (simply “CP” in the description with reference to FIG. 18) determines whether the execution object of the application that is started up according to the start-up instruction from the user has ended (step S1801).

If the CP determines that the execution object of the application that is started up according to the start-up instruction from the user has not ended (step S1801: NO), the procedure returns to step S1801. On the other hand, if the CP determines that the execution object of the application that is started up according to the start-up instruction from the user has ended (step S1801: YES), the CP deletes the context information concerning the execution object that has ended (step S1802).

The CP stops unnecessary CPUs (step S1803) and deletes from the process table, description concerning the execution object that has ended (step S1804) and the series of process steps comes to an end. The CPUs remaining after excluding the CPUs of the cluster #0 at z that is z=0 of the hierarchical multi-core processor 102 cannot directly access the process table and therefore, an instruction to delete the description concerning the execution object is given to the main CPU 101 or the CPUs of the cluster #0 at z that is z=0 also for the process of deleting from the process table similarly to the process of registering into the process table. The main CPU 101 or the CPUs of the cluster #0 at z that is z=0 executes the deleting process.

A specific example will be described of a control process of the multi-core processor system executed when a start-up instruction of an application is received from a user.

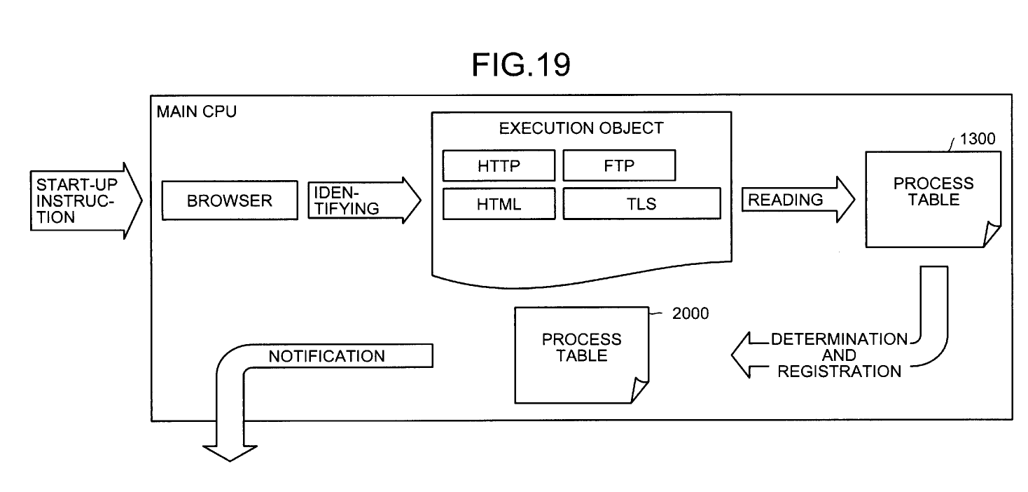

FIG. 19 is a first explanatory diagram of a second example. The main CPU 101 receives a start-up instruction for the browser and identifies an execution object by linking from the library group 502 using the linker. The main CPU 101 identifies the libraries of HTTP and FTP of the application layer, the library of HTML of the presentation layer, and the library of the TLS of the session layer as the execution object of the browser.

The main CPU 101 reads the process table 1300, determines to which cluster the execution object identified is assigned from the cluster group of the hierarchy corresponding to the hierarchy of the execution object, and registers the determination result into the process table 1300. The main CPU 101 performs control such that a different communication function is assigned to each cluster in the cluster group of each hierarchy.

Determination of the cluster to which the library of TLS is assigned will be described. For example, the process table 1300 indicates that the library of SSL is assigned to the cluster #0 and nothing is assigned to the clusters #1 to #3 for “Session_Layer:”. The main CPU 101 refers to the process table 1300 and determines the cluster to which the library of TLS is assigned from the clusters remaining after excluding the cluster #0 to which the library of SSL is assigned among the cluster group at z that is z=0. In this case, the main CPU 101 determines that the library of TLS is assigned to the cluster #1. If the process table 1300 indicates that the libraries are assigned to all of the clusters #0 to #3 for “Session_Layer:”, for example, the main CPU 101 refers to “CPU=” and determines that the cluster whose CPUs have not been assigned any thing is the cluster to which the execution object is to be assigned.

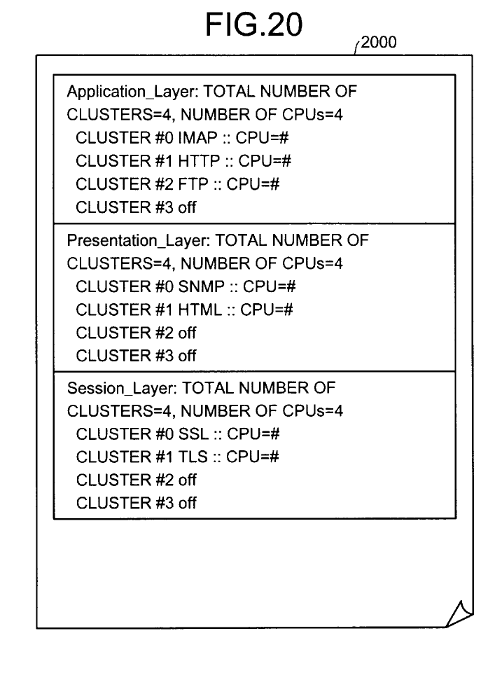

FIG. 20 is an explanatory diagram of an example where the determination result is registered in the second example. A process table 2000 is an example where the determination result is registered. Because TLS is the protocol of the session layer, TLS is indicated as being assigned to the cluster #1 for “Session_Layer:” of the process table 2000. Because HTML is the protocol of the presentation layer, HTML is indicated as being assigned to the cluster #1 for “Presentation_Layer:” of the process table 2000. Because HTTP and FTP are the protocols of the application layer, HTTP and FTP are respectively indicated as being assigned to the clusters #1 and #2 for “Application_Layer:” of the process table 2000.

Referring back to FIG. 19, after registering the determination result into the process table 2000, the main CPU 101 gives the CP of the cluster to which the process concerning each of the protocols is assigned, the start-up instruction. In this case, the main CPU 101 sequentially gives the start-up instruction to the CPs of the clusters, starting from the CP of the cluster to which the process is assigned concerning the protocol of a lower layer, up to that of a higher layer. In the second example, the main CPU 101 first gives a start-up instruction for the process concerning TLS to the CP of the cluster #1 at z that is z=0 to which the process concerning TLS is assigned; then, gives a start-up instruction for the process concerning HTML to the CP of the cluster #1 at z that is z=1 to which the process concerning HTML is assigned; gives a start-up instruction for the process concerning HTTP to the CP of the cluster #1 at z that is z=2 to which the process concerning HTTP is assigned; and gives a start-up instruction for the process concerning FTP to the CP of the cluster #2 at z that is z=2 to which the process concerning FTP is assigned.

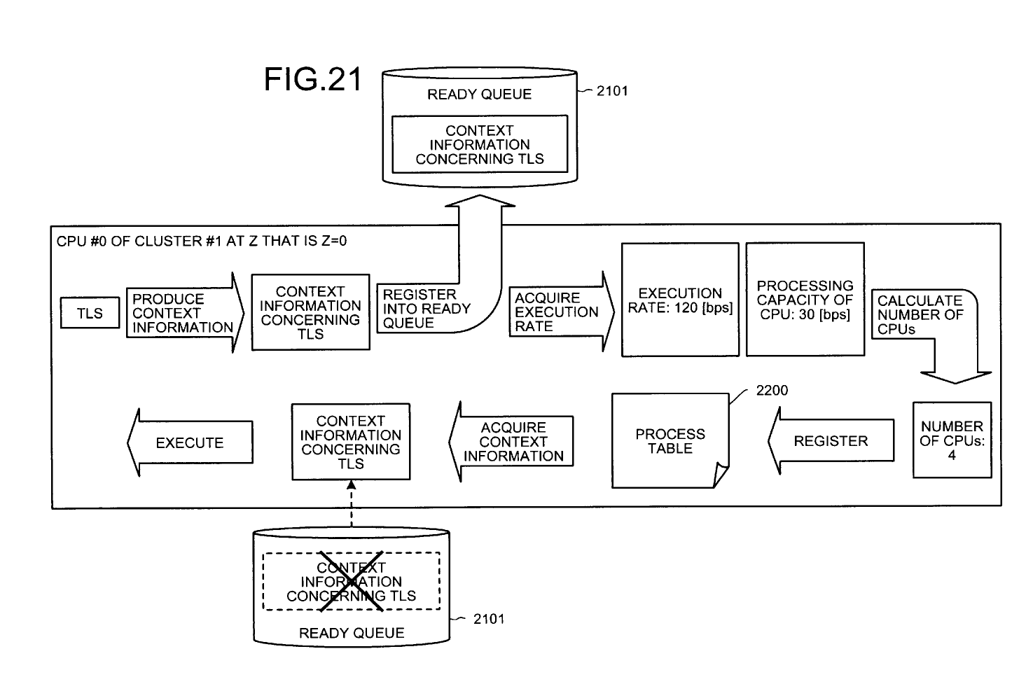

FIG. 21 is a second explanatory diagram of the second example. The process concerning TLS is assigned to the cluster #1 at z that is z=0. When the CP of the cluster #1 at z that is z=0 first receives the start-up instruction from the CPU, the CP produces the context information by mapping the process concerning TLS to the local memory and registers the context information concerning TLS produced into the ready queue 1201.

The CP of the cluster #1 at z that is z=0 acquires the execution rate and calculates the number of CPUs necessary for the process concerning TLS based on the execution rate acquired and the processing capacity of each CPU in the cluster #1. When the execution rate acquired is 120 [bps] and the processing capacity of each CPU of the hierarchical multi-core processor 102 is 30 [bps], the number of CPUs necessary for the process concerning TLS is four. The CP of the cluster #1 at z that is z=0 registers the number of CPUs calculated (calculation result) into the process table 2000.

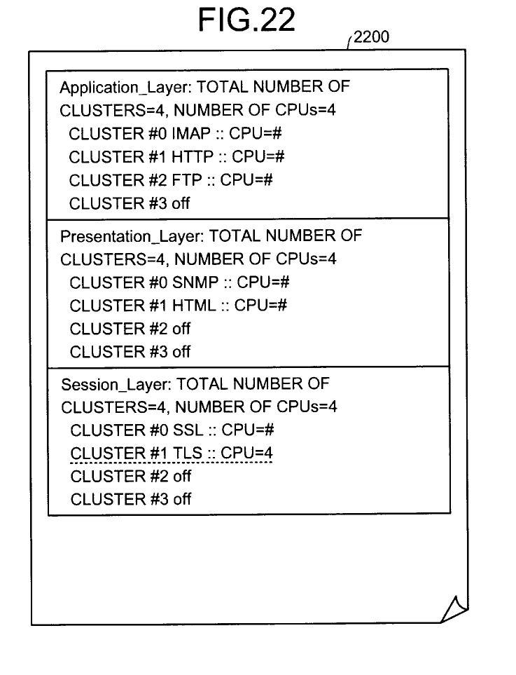

FIG. 22 is an explanatory diagram of an example where the calculation result is registered in the second example. A process table 2200 is an example where the calculation result is registered. “TLS::CPU=4” is written in the line for the cluster #1 of “Session_Layer:” in a process table 2200 and this represents that TLS is assigned to the four CPUs of the cluster #1 and is processed in parallel by the four CPUs.

Referring back to FIG. 21, the CP of the cluster #1 at z that is z=0 acquires the context information of TLS from the ready queue 2101, executes the process concerning TLS, and establishes a socket of TLS. The CP of the cluster #1 at z that is z=0 notifies the main CPU 101 of completion of the start-up of the process concerning TLS. When the main CPU 101 receives the completion of the start-up of the process concerning TLS from the CP of the cluster #1 at z that is z=0, the main CPU 101 notifies the CP of the cluster #1 at z that is z=1 of a start-up instruction of the process concerning HTML.

When the operation of the browser of the second example comes to an end, the CP of the cluster to which the execution object of the browser is assigned deletes the context information concerning the execution object and from the process table 2200, deletes the description concerning the execution object whose operation has ended. The deletion result becomes same as that of the process table 1300.

As described, according to the hierarchical multi-core processor, a CPU group is included in each hierarchy of the hierarchy group constituting the series of communication functions. The CPU group of one hierarchy of the hierarchy group is connected to the CPU group of another hierarchy constituting a communication function to be executed following the communication function of the one hierarchy and thereby, connections among the CPUs can be reduced and any increase of the scale of the system can be prevented.

The core group of each hierarchy is divided into clusters and thereby, a core group of one cluster can be caused to execute a process concerning one communication function.

Each cluster has multiple cores and thereby, one communication function can be executed in parallel and the throughput can be improved.

As described, according to the multi-core processor system and the control program, each hierarchy of the communication protocol has the CPU group and thereby, the process concerning a given communication function is assigned to the CPU group of the hierarchy corresponding to the given communication function. Thereby, a process of application software with a communication protocol can be efficiently executed.

In a case where the core group of each hierarchy is divided into multiple clusters, even when processes concerning communication protocols of the same hierarchy are simultaneously executed, each of these processes can be efficiently executed by assigning these processes to different CPUs.

When each cluster has multiple CPUs, the cores in each cluster are caused to execute, in parallel, the processes concerning the communication function assigned to each cluster and thereby, the throughput can be improved.

According to the present hierarchical multi-core processor, increases in the scale of a system can be suppressed by reducing connections among CPUs.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A hierarchical multi-core processor comprising:
a core group for each hierarchy of a hierarchy group constituting a series of communication functions divided according to communication protocol, wherein
a first core group of a given hierarchy among the hierarchy group is connected to a second core group of another hierarchy constituting a first communication function to be executed following a second communication function of the given hierarchy.

2. The hierarchical multi-core processor according to claim 1, wherein
the core group of each hierarchy is divided into a plurality of clusters.

3. The hierarchical multi-core processor according to claim 2, wherein
each cluster has a plurality of cores.

4. A multi-core processor system comprising:
a hierarchical multi-core processor that has a core group for each hierarchy of a hierarchy group constituting a series of communication functions divided according to communication protocol, where a first core group of a given hierarchy among the hierarchy group is connected to a second core group of another hierarchy constituting a first communication function to be executed following a second communication function of the given hierarchy; and
a processor that performs control to assign to the core group of each hierarchy, a communication function corresponding to the hierarchy.

5. The multi-core processor system according to claim 4, wherein
the core group of each hierarchy is divided into a plurality of clusters in the hierarchical multi-core processor, and
the processor performs control to assign a different communication function to each cluster.

6. The multi-core processor system according to claim 5, wherein
in the hierarchical multi-core processor, each cluster has a plurality of cores, and
the processor causes the cores in each cluster to execute, in parallel, a process concerning a communication function assigned to the cluster.

7. A computer-readable recording medium storing a program for causing a core that controls a hierarchical multi-core processor that has a core group for each hierarchy of a hierarchy group constituting a series of communication functions divided according to communication protocol, where a first core group of a given hierarchy among the hierarchy group is connected to a second core group of another hierarchy constituting a first communication function to be executed following a second communication function of the given hierarchy, to execute a process comprising
performing control to assign to the core group of each hierarchy, a communication function corresponding to the hierarchy.
